(19) United States
(12) Patent Application Publication
(10) Pub. No.: US 2026/0286764 A1
(43) Pub. Date: Sep. 24, 2026

(54) GLAZING HAVING IMPROVED ACOUSTIC INSULATION AND MOISTURE ABSORPTION PERFORMANCE

(71) Applicant: SAINT-GOBAIN GLASS FRANCE, COURBEVOIE (FR)

(72) Inventors: Ahmed ABBAD, COURBEVOIE (FR); Erwan BAQUET, COURBEVOIE (FR)

(21) Appl. No.: 18/880,507

(22) PCT Filed: Jun. 28, 2023
(86) PCT No.: PCT/EP2023/067746

§ 371 Date: Dec. 31, 2024

(30) Foreign Application Priority Data
Jul. 1, 2022 (FR) FR2206708

(51) Int. Cl. E06B 3/663; E06B 3/67

(52) U.S. Cl. CPC E06B 3/66361; E06B 3/6707

(57) ABSTRACT

A glazing includes at least two glass walls forming a cavity therebetween. The cavity includes at least one device including at least one plate, the plate including a plurality of perforations which are arranged periodically and delimit a chamber arranged in the cavity, the device further including desiccant device configured to absorb moisture present in the at least one chamber.

### PRIOR ART

The present invention belongs to the general field of manufacturing glazing units. More particularly, it relates to a device configured to improve the acoustic insulation performance of glazing and to limit the presence of moisture between the glass walls of said glazing. It also relates to a glazing comprising at least one such device. The invention finds a particularly advantageous application, although by no means limiting, in the case of building glazing.

Double glazings consisting of two glass panes separated by a cavity filled with gas, typically air, are conventionally used in windows and facades of buildings for their thermal and acoustic insulation performance.

However, the loss of transmission of the sound caused by such double glazing decreases for frequencies surrounding the frequency referred to as “mass/spring/mass” corresponding to the resonant frequency of the double glazing and located in the low frequencies. This phenomenon, called the mass/spring/mass effect, is due to significant variations in pressure in the air cavity at the mass/spring/mass frequency.

Also, different solutions have been developed in order to improve the acoustic insulation performance of the glazing. Document US 2010/0300800 describes acoustic glazing, in particular aircraft cockpit glazing, comprising a first glass plate separated from a second intermediate glass plate by a layer of acoustic PVB (polyvinyl butyral), the second glass plate being separated from a third glass plate by a layer of standard PVB or of polyurethane.

However, this solution does not make it possible to improve the acoustic insulation at low frequencies. To improve acoustic insulation at low frequencies, an existing passive solution is to increase the thickness of the glass plates or the thickness of the cavity of the glazing. However, this leads to cumbersome, very heavy structures with an unfavorable on-board carbon footprint.

In addition to the need to improve the acoustic performance of glazing while respecting space and weight constraints, the solutions envisaged are also subject to the problems of managing the presence of moisture between the panes forming glazing. More particularly, the aim is to be able to absorb residual water vapor in the cavity between the panes during glazing manufacture and during use thereof.

There is therefore a real need to provide a system making it possible to improve the acoustic insulation properties of a glazing, particularly in the low frequencies, as well as the performance in terms of moisture absorption thereof, while allowing a relatively lightweight and compact glazing to be obtained.

### OVERVIEW OF THE INVENTION

The present invention aims to remedy some or all of the disadvantages of the prior art, in particular those set out above, by proposing a solution that allows glazing to be obtained which is much more effective than the solutions of the prior art in terms of acoustic insulation but also of moisture absorption between the glass walls of said glazing.

Thus, according to a first aspect, the invention relates to a glazing comprising at least two glass walls forming a cavity therebetween. The cavity comprises at least one device comprising at least one plate, said plate comprising a plurality of perforations which are arranged periodically and delimiting a chamber arranged in the cavity, the device further comprising desiccant means configured to absorb moisture present in said at least one chamber.

In particular embodiments, the glazing may further comprise several of the following features, taken alone or in any technically feasible combinations.

In particular embodiments, the desiccant means comprise desiccant means arranged inside said at least one chamber, called “internal desiccant means”.

In particular embodiments, a porous absorbent material is present inside said at least one chamber, preferably selected from the group consisting of mineral wools, fibrous textile, polymer foams and combinations thereof, said fixedly arranged internal desiccant means comprising granules embedded in said porous absorbent material and/or a bar arranged in a cavity of said porous absorbent material.

In particular embodiments, the internal desiccant means comprise granules collected in at least one envelope.

In particular embodiments, at least one envelope is maintained in a fixed position by contact with an inner wall of said at least one chamber and a porous absorbent material present inside said at least one chamber, preferably selected from the group consisting of mineral wools, fibrous textile, polymer foams and combinations thereof.

In particular embodiments, said at least one envelope comprises:
two envelopes respectively arranged at opposite ends of said at least one chamber, or
three envelopes, two of which envelopes are respectively arranged at opposite ends of said at least one chamber as well as one envelope arranged substantially centrally between said two envelopes arranged at the ends.

In particular embodiments, the internal desiccant means comprise at least one plate made of a solid material, called “absorbent” plate.

In particular embodiments, said internal desiccant means comprise a stack of a first layer and a second layer, called “absorbent stack”, said two layers being preferentially parallel to the perforated plate, the first layer being a so-called absorbent plate and the second layer being a porous absorbent material present inside said at least one chamber, preferably selected from the group consisting of mineral wools, fibrous textile, polymer foams and combinations thereof.

In particular embodiments, the internal desiccant means comprise a plurality of absorbent stacks.

In particular embodiments, some or all of the internal desiccant means are maintained in a fixed position in said at least one chamber.

In particular embodiments, the desiccant means comprise desiccant means fixedly arranged outside said at least one chamber, called “external desiccant means”, in contact with the perforated plate of said at least one chamber and arranged so as to leave said perforations free.

In some embodiments, the plate of the device comprises at least three perforations, preferably at least four perforations.

In some embodiments, the perforations have a diameter or maximum dimension of 0.2 mm to 8 mm, preferably of 0.5 mm to 8 mm.

In some embodiments, the centers of the perforations are spaced apart by a distance of 5 mm to 200 mm, preferably of 10 mm to 110 mm.

In some embodiments, the plate has a thickness of 0.1 mm to 15 mm, preferably of 0.2 mm to 1 mm.

In some embodiments, the plate and the chamber are configured to resonate at a low frequency.

In some embodiments, the plate is made of metal material, preferably aluminum and/or stainless steel, and/or polymer material, preferably polyethylene, polycarbonate, polypropylene, polystyrene, polybutadiene, polyisobutylene, polyester, polyurethane, polymethyl methacrylate, polyacrylate, polyamide, polyethylene terephthalate, polybutylene terephthalate, acrylonitrile, butadiene styrene, acrylonitrile styrene acrylate, styrene-acrylonitrile copolymer, or a combination thereof, the polymer material being optionally reinforced with glass fibers.

In some embodiments, the glazing comprises at least two plates, preferably at least three plates, each comprising a plurality of perforations arranged periodically and delimiting a chamber arranged in the cavity, preferably the periodicities of the perforations of at least two of the plates, more preferentially of at least three plates, are different from one another.

In some embodiments, at least one plate of the device comprising a plurality of perforations arranged periodically and the chamber that it delimits are configured to resonate at the mass/spring/mass frequency of the glazing.

In some embodiments, the device further comprises:
at least one second plate comprising a plurality of perforations arranged periodically and delimiting a second chamber arranged in the cavity, said second plate and chamber being configured to resonate at the frequency one octave-third less than the mass/spring/mass frequency of the glazing; and
at least one third plate comprising a plurality of perforations arranged periodically and delimiting a third chamber arranged in the cavity, said third plate and chamber being configured to resonate at the frequency one octave-third greater than the mass/spring/mass frequency of the glazing.

In some embodiments, the device is a spacer device attached to each of the two glazed walls and comprises at least one rectilinear tubular profile comprising at least an upper wall, a lower wall and two side walls defining the chamber, wherein the upper wall constitutes the plate comprising a plurality of perforations arranged periodically.

In some embodiments, the chamber of the profile has a thickness, between the upper wall and the lower wall of the profile, of 2 mm to 200 mm, preferably of 5 mm to 50 mm.

In some embodiments, the device is a spacer device attached to each of the two glazed walls and comprises at least one rectilinear bar, wherein the bar constitutes the plate comprising a plurality of perforations arranged periodically, said bar defining the chamber with the two glazed walls, said chamber extending between the two glazed walls, from the bar to an edge of the glazing.

In some embodiments, the chamber has a thickness, between the bar and the edge of the glazing, of 2 mm to 200 mm, preferably of 5 mm to 50 mm.

In some embodiments, the device comprises a rectilinear casing comprising at least an upper wall, a lower wall, two longitudinal side walls and two transverse side walls defining the chamber, wherein the upper wall or one of the longitudinal side walls constitutes the plate comprising a plurality of perforations arranged periodically, the width of said casing being less than the thickness of the cavity between the two glazed walls in the same direction and, preferably, the length of said casing being less than the length of the cavity in the same direction.

In some embodiments, the chamber of the casing has a thickness, between the wall of the casing comprising the perforations arranged periodically and the wall opposite the latter, of 2 mm to 200 mm, preferably of 5 mm to 50 mm.

In some embodiments, a porous absorbent material is present inside the chamber, preferably selected from the group consisting of mineral wools, fibrous textile, polymer foams and combinations thereof.

In some embodiments, the device is positioned in a peripheral zone of the cavity of the glazing.

In some embodiments, the glazing is a building glazing, such as a glazing of a building facade, window or door, or an interior glazing.

In some embodiments, the chamber delimited by the at least one perforated plate is in fluid communication with the cavity of the glazing formed between the glass walls via the perforations in the perforated plate.

In other words, the perforations in the perforated plate open into the cavity of the glazing formed between the glass walls.

In some embodiments, the ratio between the surface area of all the perforations in the at least one perforated plate arranged periodically and the total surface area of the plate is between 0.001% and 8%.

Such a ratio ensures resonance between the perforated plate and the chamber delimited thereby.

The invention also relates to a spacer device for glazing comprising at least one rectilinear tubular profile comprising at least an upper wall, a lower wall and two side walls defining a chamber, wherein the upper wall comprises a plurality of perforations arranged periodically, with desiccant means configured to absorb moisture being present in said chamber.

The invention also relates to a spacer device for glazing comprising at least one rectilinear bar comprising a plurality of perforations arranged periodically and defining a chamber, desiccant means configured to absorb moisture being present in said chamber.

The invention also relates to a device for glazing comprising at least one rectilinear casing comprising at least an upper wall, a lower wall, two longitudinal side walls and two transverse side walls defining a chamber, wherein the upper wall or one of the longitudinal side walls comprises a plurality of perforations arranged periodically, said chamber having desiccant means configured to absorb moisture.

The present invention makes it possible to meet the need expressed herein before. It more particularly provides a device for glazing making it possible to obtain a glazing having improved acoustic insulation, particularly in the low and medium frequencies, but also in the high frequencies, while being able to be relatively light and compact.

This is accomplished by virtue of the presence, in the device, of a plate on which a plurality of perforations are periodically arranged, said plate allowing the formation of a chamber. The combination of the presence of said chamber with the presence of perforations on the plate, these perforations being periodic, allows the creation of resonators making it possible to absorb at least part of the sound energy in the cavity of the glazing formed by the two glass walls, which makes it possible to reduce the transmission of sound through the glazing. In particular, the resonators absorb the sound energy significantly for frequencies close to their resonant frequency (ies). In addition, the energy absorption also for the harmonic frequencies of the resonators as well as physical phenomena related to the modification of the properties of the gas cavity of the glazing, due to the presence of the resonators, make it possible to also improve acoustic insulation at frequencies higher than the resonant frequencies of the resonators.

Additionally, the present invention also makes it possible to meet the need for moisture absorption between the glass walls of said glazing. This is achieved through the desiccant means used to absorb moisture in a defined chamber by means of the perforated plate.

It should be noted that the various components forming the device according to the invention may be opaque or transparent or semi-transparent. This improves the visual appearance of the glazing according to the invention.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 shows on its left-hand side an example of a glazing according to the invention and, on its right-hand side, an enlarged, perspective schematic view of the profile of an example of a device according to the invention present in this example of glazing;

FIG. 2 shows on its left-hand side another example of a glazing according to the invention and, on its right-hand side, an enlarged, perspective schematic view of the casing of an example of a device according to the invention present in this example of glazing;

FIG. 3 shows on its left-hand side another example of a glazing according to the invention and, on its right-hand side, an enlarged, perspective schematic view of the bar of an example of a device according to the invention present in this example of glazing;

FIG. 4 schematically shows another particular embodiment of a glazed assembly according to the invention;

FIG. 5 shows, in flowchart form, the main steps of a method for manufacturing a glazing assembly according to the invention;

FIG. 6 schematically shows a longitudinal cross-sectional view of another particular embodiment of the device in FIG. 1;

FIG. 7 schematically shows a longitudinal cross-sectional view of another particular embodiment of the device in FIG. 1;

FIG. 8 schematically shows a longitudinal cross-sectional view of another particular embodiment of the device in FIG. 1;

FIG. 9 schematically shows a longitudinal cross-sectional view of another particular embodiment of the device in FIG. 1;

FIG. 10 schematically shows a longitudinal cross-sectional view of another particular embodiment of the device in FIG. 1;

FIG. 11 schematically shows a longitudinal cross-sectional view of another particular embodiment of the device in FIG. 1;

FIG. 12 schematically shows a longitudinal cross-sectional view of another particular embodiment of the device in FIG. 1.

### DESCRIPTION OF EMBODIMENTS

The invention is disclosed below in greater detail and in a non-limiting manner in the following disclosure.

The invention relates firstly to a device for a glazing.

The following description is intended firstly to describe, in a number of embodiments, configuration aspects of said device enabling the glazing equipped therewith to provide an excellent performance in terms of acoustic insulation.

Aspects of the configuration of the device allowing the glazing equipped therewith to significantly limit the presence of moisture between the glass walls of the glazing will be described later.

The glazing may be any type of glazing comprising at least two glazed walls defining a cavity therebetween. Within the meaning of the present invention, the cavity of a glazing is defined as being the volume between two glazed walls of said glazing.

The device according to the invention may be a spacer device for a glazing. “Spacer device” means any device making it possible to set the length of the spacing between the glazed walls of the glazing in which it is intended to be placed.

Alternatively, the device according to the invention may not be used as a spacer device.

The device according to the invention comprises at least one plate comprising a plurality of perforations arranged periodically (also referred to as “perforated plate” hereinafter).

Preferably, the plate of the device comprises, or is made of, metal material, such as aluminum and/or stainless steel, and/or a polymer material, such as s polyethylene, polycarbonate, polypropylene, polystyrene, polybutadiene, polyisobutylene, polyester, polyurethane, polymethyl methacrylate, polyacrylate, polyamide, polyethylene terephthalate, polybutylene terephthalate, acrylonitrile, butadiene styrene, acrylonitrile styrene acrylate, styrene-acrylonitrile copolymer, or a combination thereof, optionally reinforced with glass fibers.

The plate comprises two main faces opposite each other and bearing the perforations, referred to in the present text as “outer face” (corresponding to the face intended to be closest to the edge of the glazed walls of the glazing) and “inner face” (corresponding to the face intended to face the center of the cavity formed between the glazed walls of the glazing).

It is possible to define for the perforated plate a length, corresponding to the largest dimension of the plate in the plane of its main faces (also referred to as “main plane of the plate”), a width, corresponding to the dimension of the plate in a direction perpendicular to the direction of the length of the plate, in the main plane of the plate, and a thickness, corresponding to the dimension of the plate in a direction perpendicular to the main plane of the plate (and therefore corresponding to the dimension of the plate between its two main faces).

The perforated plate is preferably rectangular and parallelepiped (that is to say, it has a constant length, width and thickness).

When the device according to the invention is a spacer device, the width of the perforated plate preferably determines the length of the spacing between the glazed walls (that is to say, the thickness of the cavity between the glazed walls) of the glazing in which the spacer device is intended to be used. The plate can have a width of 6 to 30 mm, preferably of 10 to 20 mm, for example 16 mm or 20 mm, in particular in the embodiments in which the device is a spacer device.

The thickness of the perforated plate is advantageously from 0.1 to 15 mm, more preferentially from 0.2 to 1 mm. In particular, the perforated plate may have a thickness of 0.1 to 0.2 mm, or of 0.2 to 0.4 mm, or of 0.4 to 0.6 mm, or of 0.6 to 0.8 mm, or of 0.8 to 1 mm, or of 1 to 1 to 1.2 mm, or of 1.2 to 1.5 mm, or of 1.5 to 2 mm, or of 2 to 3 mm, or of 3 to 4 mm, or of 4 to 5 mm, or of 5 to 10 mm, or of 10 to 15 mm.

The plate comprises a plurality of perforations arranged periodically. “Plurality of perforations” means at least two perforations. More particularly, the plate may comprise two, or three, or at least three, or four, or at least four, or five, or at least five, or six, or at least six, or seven, or at least seven, or eight, or at least eight, or nine, or at least nine, or ten, or at least ten, perforations arranged periodically. The more perforations are arranged periodically in the plate, the more the acoustic insulation of the glazing in which the device is present is improved. In a particularly preferred way, the plate comprises at least three perforations, more preferentially at least four perforations, arranged periodically.

“Perforations arranged periodically” means that said perforations are identical and are present at regular intervals in the plate (that is to say that the distance between the centers of two adjacent perforations is constant). The perforations are made through the entire thickness of the plate (they extend from the inner face of the plate to its outer face) and allow fluid communication between the spaces located on either side of said plate (that is to say that they allow the circulation of a fluid, and more particularly of a gas, from one space to the other). Advantageously, the periodic perforations are all aligned, more preferentially along a longitudinal axis of the plate (that is to say, in the direction of its length). Even more advantageously, the perforations are arranged along a longitudinal axis of the plate located at the middle of the width of the plate.

The perforations may have any suitable shape. In certain embodiments, they have a cross section (that is to say, in the main plane of the plate) which is circular or substantially circular.

Advantageously, the perforations of the plate are microperforations. “Microperforations” means holes of which the diameter or maximum dimension (in the main plane of the plate) is less than or equal to 8 mm. Preferably, the perforations have a diameter, or a maximum dimension (in the main plane of the plate), of 0.2 to 8 mm, more preferentially of 0.5 to 8 mm. In some embodiments, the diameter or the maximum dimension of the perforations may be of 0.2 to 0.5 mm, or of 0.5 to 1 mm, or of 1 to 2 mm, or of 2 to 3 mm, or of 3 to 4 mm, or of 4 to 5 mm, or of 5 to 6 mm, or of 6 to 7 mm, or of 7 to 8 mm.

In a particularly preferred way, the periodic perforations are distributed over the entire length of the plate. Alternatively, the perforations can be arranged periodically over only part of the length of the plate, for example over a portion of the plate having a length less than or equal to 90%, or less than or equal to 80%, or less than or equal to 70%, or less than or equal to 60%, or less than or equal to 50%, or less than or equal to 40%, or less than or equal to 30%, or less than or equal to 20%, or less than or equal to 10%, of the length of the plate.

For each perforation, a geometric center of said perforation may be defined (simply referred to as “center” hereinafter). The distance between the centers of two adjacent perforations is preferably from 5 to 200 mm, more preferentially from 10 to 110 mm. The distance between the centers of two adjacent periodic perforations can be from 5 to 10 mm, or from 10 to 20 mm, or from 20 to 30 mm, or from 30 to 40 mm, or from 40 to 50 mm, or from 50 to 60 mm, or from 60 to 70 mm, or from 70 to 80 mm, or from 80 to 90 mm, or from 90 to 100 mm, or from 100 to 110 mm, or from 110 to 120 mm, or from 120 to 140 mm, or from 140 to 160 mm, or from 160 to 180 mm, or from 180 to 200 mm.

Advantageously, the open area ratio (that is to say, the ratio of the surface area of all the perforations arranged periodically and the total surface area of the plate (including the surface of the perforations)) is from 0.01 to 8%, preferably from 0.05 to 0.8%. The open area ratio can be from 0.01 to 0.05%, or from 0.05 to 0.1%, or from 0.1 to 0.2%, or from 0.2 to 0.3%, or from 0.3 to 0.4%, or from 0.4 to 0.5%, or from 0.5 to 0.6%, or from 0.6 to 0.7%, or from 0.7 to 0.8%, or from 0.8 to 0.9%, or from 0.9 to 1%, or from 1 to 2%, or from 2 to 3%, or from 3 to 4%, or from 4 to 5%, or from 5 to 6%, or from 6 to 7%, or from 7 to 8%.

The perforated plate delimits a chamber, in the device itself or in the glazing in which it is arranged. The chamber is located inside the cavity of the glazing.

The thickness of the chamber is preferably from 2 to 200 mm, more preferentially from 5 to 50 mm. The thickness of the chamber corresponds to the dimension of the chamber in a direction perpendicular to the main plane of the plate. In some embodiments, the chamber has a thickness of 2 to 5 mm, or of 5 to 10 mm, or of 10 to 20 mm, or of 20 to 30 mm, or of 30 to 40 mm, or of 40 to 50 mm, or of 50 to 60 mm, or of 60 to 70 mm, or of 70 to 80 mm, or of 80 to 90 mm, or of 90 to 100 mm, or of 100 to 120 mm, or of 120 to 140 mm, or of 140 to 160 mm, or of 160 to 180 mm, or of 180 to 200 mm.

The sizing and configuration of the plate, of its perforations and of the chamber can be selected as a function of the frequency at which the assembly formed of the plate and the chamber is sought to resonate. Indeed, the relationship between the resonant frequency f of the perforated plate and the thickness of the plate, the thickness of the chamber, the spacing between the perforations and the size and distribution of the perforations may be estimated by the formula:

$$f = 54 \; 000 \cdot \sqrt{\frac{σ}{( L + 0.8 D ) d}} \qquad [ Math . 1 ]$$

In equation 1, σ is the open surface ratio (depending on the size of the perforations and their distribution), L is the thickness of the plate in m, D is the thickness of the chamber in m and d is the distance between the centers of two adjacent perforations in m.

Advantageously, the system consisting of the plate and the chamber is configured to resonate in the low frequencies. “Low frequencies” means sound waves with a frequency of less than 300 Hz. For example, the system consisting of the plate and the chamber can be configured to resonate at a frequency less than or equal to 250 Hz, or less than or equal to 225 Hz, or less than or equal to 200 Hz, or less than or equal to 175 Hz, or less than or equal to 150 Hz. In other embodiments, the system consisting of the plate and the chamber can be configured to resonate at a frequency less than or equal to 400 Hz, or less than or equal to 350 Hz.

The plate preferably comprises a single series of perforations arranged periodically. Alternatively, it may comprise several series of perforations arranged periodically in the plate, such as at least two series or at least three series, each series being different from the others (for example, the dimension of the perforations and/or the distance between the centers of two adjacent perforations can be different in each series). When the plate comprises several series of periodic perforations, each series is located in a different portion of the plate (along its length). The presence of several different series of periodic perforations allows the system consisting of the plate and the chamber to resonate at several frequencies, each portion of the assembly of the plate and the chamber which comprises a series of different periodic perforations having a different resonant frequency.

The chamber may comprise a porous absorbent material on the inside. Preferably, “porous absorbent material” means a material characterized by a porosity greater than or equal to 0.7 and/or an airflow resistivity between 5,000 and 150,000 N·s·m⁻⁴. The porosity of the material can be measured using a porometer according to the fluid saturation method, by mercury intrusion. Airflow resistivity can be measured according to standard NF EN ISO 9053-1.

The presence of such a porous absorbent material in the chamber can make it possible to increase the acoustic performance of the device and therefore to further improve the acoustic insulation of the glazing in which it is placed.

The porous absorbent material may have a porosity greater than or equal to 0.75, or greater than or equal to 0.8, or greater than or equal to 0.85, or greater than or equal to 0.9, or greater than or equal to 0.95, for example a porosity of 0.7 to 0.75, or of 0.75 to 0.8, or of 0.8 to 0.85, or of 0.85 to 0.90, or of 0.90 to 0.95, or of 0.95 to 0.99. In a particularly preferred way, the porous absorbent material has a porosity of 0.7 to 0.99, and more preferentially greater than or equal to 0.9. The air resistivity of the porous absorbent material may be from 5,000 to 10,000 N·s·m⁻⁴, or from 10,000 to 20,000 N·s·m⁻⁴, or from 20,000 to 40,000 N·s·m⁻⁴, or from 40,000 to 60,000 N·s·m⁻⁴, or from 60,000 to 80,000 N·s·m⁻⁴, or from 80,000 to 100,000 N·s·m⁻⁴, or from 100,000 to 120,000 N·s·m⁻⁴, or from 120,000 to 140,000 N·s·m⁻⁴, or from 140,000 to 150,000 N·s·m⁻⁴. Preferably, the porous absorbent material has an air resistivity which is from 20,000 to 100,000 N·s·m⁻⁴.

The porous absorbent material is advantageously a fibrous textile, a mineral wool, a polymer foam, or a combination thereof. The fibrous textile may be a textile made of cotton fibers, flax fibers, hemp fibers, coconut fibers, polyester fibers, cellulose fibers, or a combination thereof. The mineral wool may be selected from the group consisting of glass wool, rock wool and combinations thereof. The polymer foam may be selected from the group consisting of melanin foams, polyurethane foams, polyethylene foams, and combinations thereof.

The porous absorbent material may fill the entire chamber. Alternatively, the porous absorbent material may be present only in part of the chamber, for example the volume of the porous absorbent material may be from 2 to 20%, or from 20 to 40%, or from 40 to 60%, or from 60 to 80%, or from 80 to 98%, of the total volume of the chamber.

Alternatively, or in addition, the chamber may comprise a gas. The gas may in particular be air and/or argon, and/or carbon dioxide, and/or krypton and/or xenon.

The perforations may be covered by a fabric, in part or, preferably, entirely. For example, the fabric can be bonded by any suitable means onto the plate, such as onto the inner face of the plate. Alternatively, or additionally, the fabric may be arranged on a porous absorbent material as described hereinbefore, for example bonded to said porous absorbent material, the porous absorbent material being placed inside the chamber, so that the fabric is against all or part, preferably all, of the perforations. The fabric thus forms against the perforations a screen having a certain resistivity. Without seeking to be bound by any one theory, the inventors estimate that when the sound wave passes through the fabric in order to penetrate the chamber, it encounters a resistivity due to the presence of the fabric, which improves the absorption of the sound energy and therefore the acoustic insulation of the glazing comprising the device at the low, medium and high frequencies. When the fabric is attached to a porous absorbent material positioned in the chamber, the acoustic insulation of the glazing is further improved. The fabric advantageously has a thickness ranging from 0.1 to 3 mm, preferably from 0.2 to 1 mm. The fabric may be made of any woven natural or synthetic fibers, such as for example cotton fibers and/or flax fibers. The fabric preferably has a porosity of 0.07 to 0.99, and more preferentially of 0.5 to 0.99, and/or an air resistivity of 90,000 to 3,500,000 N·s·m⁻⁴, more preferentially from 300,000 to 3,000,000 N·s·m⁻⁴. The air resistivity and the porosity can be measured as indicated hereinbefore. The fabric may have a porosity of 0.07 to 0.2, or of 0.2 to 0.4, or of 0.4 to 0.6, or of 0.6 to 0.8, or of 0.8 to 0.99. The airflow resistivity of the fabric may be from 90,000 to 300,000 N·s·m⁻⁴, or from 300,000 to 500,000 N·s·m⁻⁴, or from 500,000 to 1,000,000 N·s·m⁻⁴, or from 1,000,000 to 1,500,000 N·s·m⁻⁴, or from 1,500,000 to 2,000,000 N·s·m⁻⁴, or from 2,000,000 to 2,500,000 N·s·m⁻⁴, or from 2,500,000 to 3,000,000 N·s·m⁻⁴, or from 3,000,000 to 3,500,000 N·s·m⁻⁴.

Advantageously, the inside of the chamber consists of gas and/or one or more porous absorbent materials as described hereinbefore, optionally covered with a fabric as described hereinbefore.

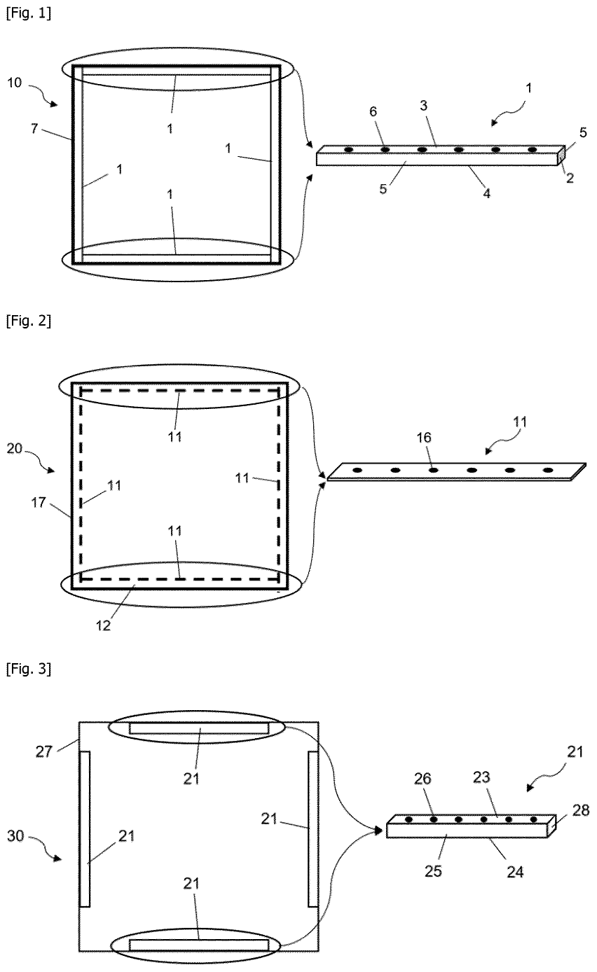

Referring to FIG. 1, according to a first variant, the device according to the invention comprises at least one rectilinear tubular profile 1. “Tubular profile” means a hollow profile, that is to say a profile comprising a cavity or chamber 2. “Rectilinear profile” means that the profile is straight in the direction of its length (a longitudinal axis of the profile may therefore be defined). According to this variant, the device is advantageously a spacer device.

The tubular profile 1 comprises at least an upper wall 3, a lower wall 4 and two side walls 5 defining the chamber 2 of the profile. In the present text, the terms “upper” and “lower” are used referring to the orientation of the profile 1 shown on the right-hand side of FIG. 1. However, the profile 1 may of course have any possible orientation, such as, for example, an orientation according to which the longitudinal axis of the profile is vertical or an orientation according to which the upper wall is below the lower wall (as shown in the left-hand side of FIG. 1).

The upper wall 3 comprises a plurality of perforations 6 arranged periodically. Thus, the profile 1 according to the invention is also referred to as “perforated (rectilinear) (tubular) profile” in the present text. The perforations 6 are made over the entire thickness of the upper wall and place the chamber 2 of the profile in fluid communication with the environment outside the profile (that is to say that they allow the circulation of a fluid, and more particularly a gas, from the chamber 2 of the profile toward the outside environment and vice versa).

In this first variant, the upper wall 3 of the profile corresponds to the plate comprising a plurality of perforations arranged periodically of the device described hereinbefore, and the chamber 2 of the profile corresponds to the chamber delimited by the plate described hereinbefore. Thus, all that is described in the present text in relation to the perforated plate and in relation to the chamber delimited by the perforated plate applies to the upper wall 3 of the profile 1 and to the chamber 2 of the profile, respectively.

In this variant, the thickness of the chamber inside the profile 1 is the distance between the upper wall 3 and the lower wall 4 of the profile 1.

The upper wall 3 and the lower wall 4 of the profile may be connected by two side walls 5 (each of the two side walls 5 connecting a longitudinal edge of the upper wall 3 to a longitudinal edge of the lower wall 4). In other embodiments, the upper wall 3 and the lower wall 4 can be connected to one another by any number of walls.

Advantageously, the main plane of the upper wall 3 and the main plane of the lower wall 4 are parallel to one another and, still more advantageously, they are perpendicular to the main planes of the two side walls 5.

Preferably, the rectilinear profile 1 comprises, or is made of, a material as mentioned hereinbefore relative to the perforated plate.

Preferably, the lower wall 4 and/or each of the two side walls 5 has a rectangular parallelepiped shape.

Advantageously, the length of the upper wall 3 of the profile 1 is equal to the length of the cavity between the glazed walls 7 of the glazing 10 in which the device is intended to be placed, in the same direction.

Referring to FIG. 2, according to a second variant, the device according to the invention comprises at least one rectilinear bar 11. “Bar” means a solid of rectangular parallelepiped shape. The bar comprises a plurality of perforations 16 arranged periodically. Thus, the bar 11 according to the invention is also referred to as “perforated (rectilinear) bar” in the present text. According to this second variant, the device is advantageously a spacer device.

In this second variant, the bar 11 corresponds to the plate comprising a plurality of periodically arranged perforations of the device. Thus, all that is described in the present text in connection with the perforated plate applies to the perforated bar.

When it is placed in a glazing 20 (between two glazed walls 17 of the glazing), the perforated bar according to the invention defines a chamber 12 between the glazed walls. This chamber 12 extends from the perforated bar 11 to one of the edges of the glazed walls 17. This edge is advantageously the edge of the glazed walls 17, preferably parallel to the perforated rectilinear bar 11, closest to the perforated rectilinear bar 11.

In this second variant, the chamber 12 formed between the glazed walls extending from the perforated bar to the edge of the glazed walls corresponds to the chamber delimited by the plate described hereinbefore. Thus, all that is described in the present text in relation to the chamber delimited by the perforated plate applies to the chamber 12 formed between the glazed walls extending from the perforated bar to the edge of the glazed walls.

In this variant, the thickness of the chamber 12 corresponds to the dimension of the chamber between the perforated bar 11 and the edge of the glazed walls 17.

Advantageously, the length of the bar 11 is equal to the length of the cavity between the glazed walls 17 of the glazing 20 in which it is intended to be placed, in the same direction.

Referring to FIG. 3, according to a third variant, the device according to the invention comprises at least one rectilinear casing 21. “Casing” means a hollow closed structure, that is to say, comprising a cavity or chamber.

The casing comprises at least an upper wall 23, a lower wall 24, two longitudinal side walls 25 (preferably opposite each other) and two transverse side walls 28 (preferably opposite each other) defining the chamber of the casing. “Longitudinal side wall” means a side wall parallel to the longitudinal axis of the rectilinear casing, and “transverse side wall” means a side wall perpendicular to the longitudinal axis of the rectilinear casing. In the present text, the terms “upper” and “lower” are used referring to the orientation of the casing 21 shown on the right-hand side of FIG. 3. Of course, the casing can have any other possible orientation, as shown for example on the left-hand side of FIG. 3. The upper wall 23 of the casing corresponds to the wall intended to face the center of the cavity formed between the glazed walls 27 of the glazing 30, the lower wall 24 corresponds to the wall of the casing 11 intended to be closest to the edge of the glazed walls 27 of the glazing 30, the longitudinal side walls 25 are intended to be parallel to the glazed walls 27 and the transverse side walls 28 are intended to be perpendicular to the glazed walls 27.

The upper wall 23 and the lower wall 24 of the casing can be connected by two longitudinal side walls 25 (each of the two longitudinal side walls 25 connecting a longitudinal edge of the upper wall 23 to a longitudinal edge of the lower wall 24). In other less preferred embodiments, the upper wall 23 and the lower wall 24 can be connected to each other by any number of longitudinal walls 25. The upper wall 23 and the lower wall 24 of the casing are preferably connected to each other by two transverse side walls 28 (each of the two transverse side walls 28 connecting a transverse edge of the upper wall 23 to a transverse edge of the lower wall 24)

Advantageously, the main plane of the upper wall 23 and the main plane of the lower wall 24 are parallel to each other. Preferably, the main planes of the longitudinal side walls 25 are parallel to each other. Preferably, the main planes of the transverse side walls 28 are parallel to each other. Even more advantageously, the main planes of the upper 23 and lower 34 walls are perpendicular to the main planes of the two longitudinal side walls 25 and to the main planes of the two transverse side walls 28. In a particularly preferred way, the casing 21 according to the invention has a parallelepiped shape, even more preferentially a rectangular parallelepiped shape.

Each of the walls of the casing 21 can independently have a rectangular parallelepiped shape, preferably each of the walls of the casing 21 has a rectangular parallelepiped shape.

In this third variant, it is possible to define for the casing 21 a length corresponding to the dimension of the casing 21 along the longitudinal axis of the rectilinear casing and a width matching the size of the casing 21 in a direction perpendicular to the longitudinal axis of the rectilinear casing, in the main plane of the upper wall 23 of the casing. In a particularly preferred way, the width of the casing 21 is less than the thickness of the cavity between the glazed walls 27 (in the same direction) of the glazing 30 in which it is intended to be placed. Thus, in this variant, the device is preferably not a spacer device. Preferably, at least one of the longitudinal side walls 25 (only one or both) is not in contact with a glazed wall 27 when the casing is placed in a glazing 30.

The width of the casing 21 can be from 1 to 99% of the thickness of the cavity between the glazed walls of the glazing, for example from 1 to 10%, or from 10 to 20%, or from 20 to 30%, or from 30 to 40%, or from 40 to 50%, or from 50 to 60%, or from 60 to 70%, or from 70 to 80%, or from 80 to 90%, or from 90 to 99% of the thickness of the cavity between the glazed walls 27. The width of the casing 21 may be from 5 mm to less than the thickness of the cavity between the glazed walls 27, for example the width of the casing 21 may be from 5 mm to 29 mm, or from 5 mm to 19 mm, or from 5 mm to 15 mm.

The length of the casing 21 may be less than or equal to the length of the cavity between the glazed walls 27 of the glazing 30 in which it is intended to be placed, in the same direction. Preferably, it is less than the length of the cavity in the same direction. The length of the casing 21 can be from 1 to 100% of the length of the cavity, for example from 1 to 10%, or from 10 to 20%, or from 20 to 30%, or from 30 to 40%, or from 40 to 50%, or from 50 to 60%, or from 60 to 70%, or from 70 to 80%, or from 80 to 90%, or from 90 to 95%, or from 95 to 100% of the length of the cavity between the glazed walls 27. In certain embodiments, the length of the casing 21 can be from 5 cm to the length of the cavity between the glazed walls 27 (in the same direction as the length of the casing 21).

The upper wall 23 or one of the longitudinal side walls 25 (intended not to be in contact with a glazed wall 27 of the glazing 30 when the casing is placed in a glazing) comprises a plurality of perforations 26 arranged periodically. Thus, the casing 21 according to the invention is also referred to as “perforated (rectilinear) casing” in the present text. The perforations 26 are made over the entire thickness of the wall and place the chamber of the casing 21 in fluid communication with the environment outside the casing 21.

In this third variant, the wall of the casing 21 comprising the periodic perforations 26 corresponds to the plate comprising a plurality of perforations arranged periodically of the device described hereinbefore, and the chamber of the casing 21 corresponds to the chamber delimited by the plate described hereinbefore. Thus, all that is described in the present text in relation to the perforated plate and in relation to the chamber delimited by the perforated plate applies to the perforated wall of the casing 21 and to the chamber of the casing, respectively.

In this variant, the thickness of the chamber inside the casing 21 is the distance between the wall of the casing comprising the periodic perforations (the upper wall 23 or one of the longitudinal side walls 25) and the wall opposite this wall.

Preferably, the casing 21 comprises, or is made of, a material as mentioned hereinbefore in relation to the perforated plate.

The device according to the invention may be according to several of the variants described hereinbefore at a time. Thus, the device according to the invention may simultaneously comprise one or more perforated profiles 1 and one or more perforated bars 11; simultaneously one or more perforated profiles 1 and one or more perforated casings 21; simultaneously one or more perforated bars 11 and one or more perforated casings 21; or simultaneously one or more perforated profiles 1, one or more perforated bars 11 and one or more perforated casings 21.

The device according to the invention may comprise a single perforated plate. In particular, the device according to the invention can comprise a single rectilinear tubular profile 1 comprising perforations 6 in its upper wall 3 or a single perforated rectilinear bar 11 or a single perforated rectilinear casing 21. However, preferably, the device comprises several perforated plates. More particularly, it advantageously comprises several rectilinear tubular profiles 1 each comprising an upper wall 3 comprising perforations 6 arranged periodically and/or several rectilinear bars 11 comprising perforations 16 arranged periodically and/or several rectilinear casings 21 comprising perforations 26 arranged periodically in one of its walls. When the device comprises several perforated plates, for example several perforated rectilinear tubular profiles 1 and/or perforated rectilinear bars 11 and/or perforated casings 21, said perforated plates, perforated rectilinear tubular profiles, perforated rectilinear bars and perforated rectilinear casings each independently may be as described hereinbefore.

Preferably, when the device comprises several perforated plates, at least some of them are different from one another and they can all be different from one another and/or at least certain chambers delimited by said perforated plates are different from one another and they can all be different from one another. In particular, when the device comprises several perforated rectilinear tubular profiles 1, preferably at least some of them are different from one another and they can all be different from one another. More particularly, they may have perforations 6 with a different periodicity, that is to say perforations 6 of different size and/or perforations 6 arranged differently in the upper wall 3 (for example the distance between the centers of two adjacent perforations 6 may be different). Alternatively, or additionally, they may have an upper wall 3 of different thickness and/or a chamber 2 of different thickness. When the device comprises several perforated bars 11, preferably at least some of them are different from one another and they can all be different from one another. In particular, they may have perforations 16 with a different periodicity, that is to say perforations 16 of different size and/or perforations 16 arranged differently (for example the distance between the centers of two adjacent perforations 16 may be different), and/or have a different thickness. Alternatively, or additionally, at least some chambers 12 defined between said perforated bars and the edges of the glazed walls may be different from one another and they may all be different from one another, in particular the chambers 12 may have a different thickness. When the device comprises several perforated rectilinear casings 21, preferably at least some of them are different from one another and they can all be different from one another. More particularly, they may have perforations 26 with a different periodicity, that is to say perforations 26 of different size and/or perforations 26 arranged differently in the wall (for example the distance between the centers of two adjacent perforations 26 can be different). Alternatively, or additionally, they can have a wall having the perforations of different thickness and/or a chamber 12 of different thickness. Thus, preferably, the perforated plates (in particular the perforated rectilinear tubular profiles 1 and/or the perforated rectilinear bars 11 and/or the perforated rectilinear casings 21) and the chambers that they delimit are such that at least some of the perforated plates, or all of them, resonate, with the chambers that they delimit, at different frequencies.

The device may comprise two or at least two perforated plates (for example, two or at least two perforated rectilinear tubular profiles 1 and/or perforated rectilinear bars 11 and/or perforated rectilinear casings 21) (as described hereinbefore), or three or at least three perforated plates (for example, three or at least three perforated rectilinear tubular profiles 1 and/or perforated rectilinear bars 11 and/or perforated rectilinear casings 21), or four or at least four perforated plates (for example, four or at least four perforated rectilinear tubular profiles 1 and/or perforated rectilinear bars 11 and/or perforated rectilinear casings 21), or five or at least five perforated plates (for example, five or at least five perforated rectilinear tubular profiles 1 and/or perforated rectilinear bars 11 and/or perforated rectilinear casings 21). Preferably, at least two of the perforated plates (for example at least two of the perforated profiles 1 and/or the perforated bars 11 and/or the perforated rectilinear casings 21) have perforations with a different periodicity (that is to say the periodicity of the perforations of a plate (for example of a profile or of a bar or a casing) is different from the periodicity of the perforations of another plate (for example of another profile or of another bar or of another casing), more preferentially, at least three of the perforated plates (for example at least three of the perforated profiles 1 and/or of the perforated bars 11 and/or of the perforated casings 21) have perforations with a different periodicity.

In a particularly preferred manner, the device according to the invention comprises three perforated plates, and more particularly three perforated rectilinear tubular profiles 1 and/or perforated rectilinear bars 11 and/or perforated rectilinear casings 21, or at least three perforated plates, more particularly at least three perforated rectilinear tubular profiles 1 and/or perforated rectilinear bars 11 and/or perforated rectilinear casings 21, and more preferably four (or at least four) perforated plates, and more particularly four (or at least four) perforated rectilinear tubular profiles 1 and/or perforated rectilinear bars 11 and/or perforated rectilinear casings 21. More preferentially three or at least three of these plates (in particular three or at least three of these profiles 1 and/or bars 11 and/or casings 21), with the chambers that they delimit, are configured to resonate at different frequencies.

Even more preferably, the device comprises at least:
a first perforated plate delimiting a first chamber (in particular a first perforated profile 1 or a first bar 11 or a first casing 21), the system consisting of the first perforated plate and the first chamber being configured to resonate at a first frequency,
a second perforated plate delimiting a second chamber (in particular a second perforated profile 1 or a second bar 11 or a second casing 21), the system consisting of the second perforated plate and the second chamber being configured to resonate at a second frequency corresponding to one octave-third below the first frequency, and
a third perforated plate delimiting a third chamber (in particular a third perforated profile 1 or a third bar 11 or a third casing 21), the system consisting of the third perforated plate and the third chamber being configured to resonate at a third frequency corresponding to one octave-third above the first frequency

The device may further comprise one or more non-perforated plates (for example one or more profiles, preferably tubular and preferably rectilinear, and/or bars, preferably rectilinear, and/or casings, preferably rectilinear) and/or one or more plates (for example one or more profiles, preferably tubular and preferably rectilinear, and/or bars, preferably rectilinear and/or casings, preferably rectilinear) comprising non-periodic perforations.

Preferably, the device comprises as many plates (more particularly profiles and/or bars and/or casings) as the number of sides of the glazed walls of the glazing in which it is intended to be placed, for example it comprises four plates (and more particularly four profiles and/or bars and/or casings).

The plates of the device may be disjointed (all or some of them) or may be joined to one another (all or some of them), preferably at their ends. Preferably, when the device according to the invention is a spacer device, all the plates of the spacer device are joined so as to form a frame. When the plates are joined, they can form a single piece (the plates originate for example from a single plate folded in one or more locations, for example to form the corners of the frame) or may be assembled together by any suitable means, for example by means of staples, glue, clips and/or interlocking. In particular, when the device comprises profiles, these may be disjointed (all or some of them) or may be joined to one another (all or some of them), preferably at their ends. Preferably, all the profiles of the device are joined so as to form a frame. When the profiles are joined, they can form a single piece (the rectilinear profiles originate for example from a single profile folded in one or more locations, for example to form the corners of the frame) or may be assembled together by any suitable means, for example by the means indicated hereinbefore. Likewise, when the device comprises rectilinear bars, the latter may be disjointed (all or some of them) or may be joined to one another (all or some of them), preferably at their ends. Preferably, all the bars of the device are joined so as to form a frame. When the bars are joined, they can form a single piece or can be assembled together by any suitable means, for example by the means indicated hereinbefore. In embodiments in which the device comprises profiles and bars, the upper walls of the profiles and the bars may be joined or disjointed. When the device comprises rectilinear casings, they are advantageously disjointed.

When the device comprises several plates, the chambers that they delimit (for example the chambers 2 in the profiles 1 of the device and/or the chambers 12 formed between the glazed walls of the glazing extending from the rectilinear bars to the edges of the glazing) can be closed relative to one another (that is to say that they are not directly in fluid communication with one another), for example by the presence of a partition between the chambers, or may be communicating with one another, or some may be closed relative to one another and others communicating with one another. However, when the plates of the device belong to perforated rectilinear casings 21, the chambers that they delimit, that is to say the chambers inside said casings, are closed relative to one another (that is to say, they are not directly in fluid communication with one another).

The invention also relates to a glazing comprising a device as described hereinbefore.

The glazing according to the invention comprises at least two glazed walls. Advantageously, the glazed walls are parallel or substantially parallel to one another.

In some embodiments, the glazing according to the invention may comprise exactly two glass walls (it is then called “double glazing”), or exactly three glass walls (it is then called “triple glazing”), or at least three glass walls, for example four glass walls (it is then called “quadruple glazing”).

Within the meaning of the present invention, a “glazed wall” refers to any structure comprising (or consisting of) at least one glass sheet or a glazed assembly. “Glazed assembly” is understood to mean a multilayer glazed element of which at least one layer is a glass sheet. Thus, the glazed walls may for example independently comprise a single glass sheet or alternatively a glazed assembly, for example one made of a laminated glazing (as described in more detail below).

The glass sheet can be made of organic or mineral glass. It can be made of tempered glass.

The glazed walls (or one of the glazed walls) may comprise (or consist of) a glazed assembly comprising at least one glass sheet which may be as described above. The glazed assembly is preferably a laminated glazing. The term “laminated glazing” is understood to mean at least two glass sheets between which at least one interlayer film generally made of viscoelastic plastic material is inserted. The interlayer film made of viscoelastic plastic material may comprise one or more layers of a viscoelastic polymer such as polyvinyl butyral (PVB) or an ethylene vinyl acetate copolymer (EVA), or an ethylene copolymer (corresponding to the definition of an ionomer), more preferentially PVB. The interlayer film can be made of standard PVB or of acoustic PVB (such as single-layer or tri-layer acoustic PVB). Acoustic PVB generally consists of three layers: two outer layers of standard PVB and an inner layer of PVB with added plasticizer so as to make it less rigid than the outer layers. The use of glazed walls comprising a laminated glazing makes it possible to improve the acoustic insulation of the glazing, the acoustic insulation being further increased when the interlayer film is made of acoustic PVB.

Each glazed wall includes two main faces opposite one another corresponding to the faces of the glazed wall having the largest surface areas. Advantageously, the glazed walls independently have a thickness (between their two main faces) greater than or equal to 1.6 mm, for example a thickness of 1.6 to 24 mm, preferably of 2 to 12 mm, more preferably of 4 to 10 mm, for example 4 or 6 mm. The glazed walls of the glazing according to the invention may all have the same thickness or have different thicknesses. The greater the thickness and/or the higher the density of the glazed walls, the greater the acoustic insulation. Furthermore, the thicker the glazed walls, the lower the mass/spring/mass of the glazing.

Preferably, all the glazed walls of the glazing have identical height and width. The glazing according to the invention may have any possible form, and preferably has a quadrilateral shape, in particular a rectangular or substantially rectangular shape. Alternatively, the glazing may have a circular, or substantially circular, shape, or an elliptical, or substantially elliptical shape, or a trapezoidal or substantially trapezoidal shape.

The glazed walls define a cavity between them. Each of the glazed walls defining the cavity comprises an inner face corresponding to the main face of the glazed wall facing the cavity in question and an outer face corresponding to the second main face of the glazed wall, that is to say corresponding to the main face of the glazed wall opposite the face facing the cavity.

Advantageously, the device according to the invention is positioned in the cavity of the glazing, more particularly in a peripheral zone of the cavity of the glazing. By “peripheral zone of the cavity” means an area of the cavity adjacent to the edges of the glazed walls and preferably whose width (that is in a direction orthogonal to the edge of the glazed walls, in the plane of the glazed walls) is less than or equal to 20 cm, more preferably less than or equal to 10 cm, more preferably less than or equal to 5 cm.

Preferably, when the device is a spacer device (in particular, when it comprises one or more perforated profiles and/or perforated bars), the one or more perforated plates of the spacer device are each parallel to an edge of the glazed walls (for example, the one or more perforated rectilinear profiles and/or the perforated rectilinear bars are each parallel to an edge of the glazed walls). When the device comprises one or more perforated casings, the perforated casing(s) are preferably each parallel to one edge of the glazed walls.

In a particularly preferred way, the device is placed in the cavity of the glazing so that the chamber delimited by the perforated plate is in fluid communication with the cavity of the glazing formed between the glass walls via the perforations in the plate. Thus, preferably, when the device comprises at least one perforated profile 1, it is placed in the cavity of the glazing so that the upper wall 3 of the profile(s) 1 faces the inside of the cavity of the glazing, the lower wall 4 of the profile(s) 1 being turned toward the outside and the edges of the glazing. Thus, the chamber 2 of the perforated profile(s) 1 is in fluid communication with the cavity of the glazing via the perforations 6 present in the upper wall 3 of said profiles 1 (that is to say that a fluid, and preferably a gas, can circulate from the cavity of the glazing to the inside of the chamber 2 of the profiles 1, and vice versa). When the device comprises at least one perforated casing 21, it is placed in the cavity of the glazing so that the wall having the periodic perforations 26 is either facing the center of the cavity of the glazing, or facing a glazed wall without being in contact with same.

When the device is a spacer device, the two glazed walls are attached to the spacer device.

More preferentially, when the spacer device comprises at least one perforated profile 1, they are attached to the side walls 5 of the profile(s) 1 of the spacer device, even more preferentially their inner face is attached each to a side wall 5 of the profile(s) 1 of the spacer device.

When the spacer device comprises at least one perforated bar 11, the two glazed walls are preferentially attached to side faces of the bar 11 that are opposite one another.

Advantageously, the glazed walls are attached to the spacer device by bonding, for example by an adhesive, such as a polyisobutylene (PIB) based adhesive, by a silicone mastic or by a double-sided adhesive tape.

A tightness seal can also be present, preferably arranged on the outer face of the spacer device (that is to say the face of the spacer device closest to the edge of the glazed walls), which is preferably the outer face of the lower wall 4 of the profile(s) 1 of the spacer device (when the spacer device comprises at least one perforated profile 1). More preferentially, the tightness seal extends from this outer face to the edge of the glazed walls. This tightness seal can be made with a mastic (referred to as “sealant mastic”) based on polyurethane, polysulfide and/or silicone. However, when the spacer device comprises a perforated bar 11, preferably no tightness seal is present on said bar.

The spacer device makes it possible to set the length of the spacing between the glazed walls. The length of this spacing (that is to say, the thickness of the cavity between the glazed walls) can be from 6 to 30 mm, preferably from 10 to 20 mm, for example 16 mm.

When the device according to the invention is not a spacer device, for example when it comprises one or more perforated casings 21, said device, and in particular the perforated casings 21, may be placed on a spacer device. More preferentially, the lower wall 24 of the casing can rest on the spacer device. When the length of the casing is less than the length of the cavity between the glazed walls, the casing 21 can be located in any location in the peripheral zone of the cavity of the glazing.

Preferably, the cavity of the glazing (between the glazed walls) comprises a gas. The gas may be air and/or carbon dioxide, and/or argon, and/or krypton and/or xenon. The use of argon, krypton or xenon, in addition to or as a replacement for air, makes it possible to improve the thermal insulation of the glazing.

The glazing according to the invention can be totally opaque, totally transparent, or partially opaque and partially transparent. Preferably, the glazing is at least partially transparent.

One (or more) of the glazed walls may be tinted in its thickness over all or part of its surface. One (or more) of the glazed walls may be entirely or partly covered with an opaque coating, for example a paint and/or an enamel. The opaque coating may be present on the inner face of the glazed wall, or on its outer face, or on both faces, preferably it coats the inner face of the glazed wall. In some embodiments, only one of the glazed walls of the glazing is covered with an opaque coating. This glazed wall is advantageously the glazed wall intended to be the outermost glazed wall of the glazing when the latter is used in a building facade or exterior window.

In some embodiments, the glazed walls of the glazing, or at least one of the glazed walls, may have undergone a treatment in order to improve the thermal insulation of the glazing. In particular, the glazed wall(s) may comprise one (or more) insulating layer(s) such as an insulating layer based on metal and/or metal oxide, on one or more of their main faces, preferably on the inner face. When the glazed wall is also covered with an opaque coating (such as an enamel and/or a paint), an insulating layer compatible with the opaque coating is preferably used. Alternatively, the insulating layer and the opaque coating can be arranged on different faces of the glazed wall (for example, the insulating layer may be on the inner face and the opaque coating on the outer face). Again alternatively, when at least one of the glazed walls is a glazed assembly, the insulating layer can be interposed in the glazed assembly, for example between a PVB layer and a glass sheet.

Advantageously, at least one of the perforated plates of the device and the chamber that it delimits are such that the assembly consisting of said perforated plate and said chamber resonates at the called “mass/spring/mass” frequency of the glazing (for example, at least one of the profiles 1 of the device comprising, on its upper wall 3, perforations 6 arranged periodically is such that it resonates at the mass/spring/mass frequency of the glazing and/or at least one of the bars 11 comprising perforations 16 arranged periodically and the chamber 12 that it delimits are such that they resonate at the mass/spring/mass frequency of the glazing and/or at least one of the casings 21 comprising perforations 26 arranged periodically is such that it resonates at the mass/spring/mass frequency of the glazing). The presence in the glazing according to the invention of plates (and more particularly of profiles and/or bars and/or casings) and chambers configured to resonate at the mass/spring/mass frequency of the glazing or at a frequency close to same makes it possible to increase the loss of transmission of sound at the frequencies close to the mass/spring/mass frequency of the glazing but also at the frequencies higher than the mass/spring/mass frequency.

The mass/spring/mass frequency fₘₛₘ of the glazing may be determined by the following formula:

$${f}_{msm} = \frac{1}{2 π} \sqrt{\frac{{ρ}_{0} {c}_{0}^{2}}{d} ( \frac{{m}_{s 1} + {m}_{s 2}}{{m}_{s 1} {m}_{s 2}} )} \qquad [ Math . 2 ]$$

In equation 2, ρ₀ is the density of the air in kg/m³, c₀ is the speed of sound in the air cavity in m/s, d is the thickness of the air cavity between the two glass walls in m and mₛ₁ and mₛ₂ are respectively the masses per surface area unit of the first and second glass wall in kg/m².

Preferably, at least one of the perforated plates of the device and the chamber delimited thereby (more particularly at least one of the profiles 1 of the device comprising on its upper wall 3 perforations 6 arranged periodically and/or at least one of the bars 11 of the device comprising perforations 16 arranged periodically and the chamber 12 delimited thereby and/or at least one of the casings 21 of the device comprising perforations 26 arranged periodically) are configured to resonate at a frequency corresponding to one octave-third less than the mass/spring/mass frequency of the glazing, or at a frequency close thereto. This makes it possible to increase the loss of transmission of sound at the frequencies close to this frequency.

Preferably, at least one of the perforated plates of the device and the chamber delimited thereby (more particularly at least one of the profiles 1 of the device comprising on its upper wall 3 perforations 6 arranged periodically and/or at least one of the bars 11 of the device comprising perforations 16 arranged periodically and the chamber 12 delimited thereby and/or at least one of the casings 21 of the device comprising perforations 26 arranged periodically) are configured to resonate at a frequency corresponding to one octave-third higher than the mass/spring/mass frequency of the glazing, or at a frequency close thereto. This makes it possible to increase the loss of transmission of sound at the frequencies close to this frequency.

The presence, in the glazing, of a device comprising at least two perforated plates delimiting a chamber (in particular at least two perforated profiles 1 and/or perforated rectilinear bars 11 and/or perforated rectilinear casings 21), at least one plate of which forms with the chamber that it delimits a system configured to resonate at the mass/spring/mass frequency of the glazing and at least one other plate forms with the chamber that it delimits a system configured to resonate at one octave-third greater than or less than the mass/spring/mass frequency of the glazing, and preferably at least three perforated plates delimiting a chamber (in particular at least three perforated profiles 1 and/or perforated rectilinear bars 11 and/or perforated rectilinear casings 21), at least one plate of which forms with the chamber that it delimits a system configured to resonate at the mass/spring/mass frequency of the glazing, at least one other plate forms with the chamber that it delimits a system configured to resonate at one octave-third greater than the mass/spring/mass frequency of the glazing and at least one other plate forms with the chamber that it delimits a system configured to resonate at one octave-third less than the mass/spring/mass frequency of the glazing, makes it possible to smooth out the sound transmission loss around the mass/spring/mass frequency of the glazing and improve the sound insulation of the glazing over a wider frequency band around the mass/spring/mass frequency of the glazing.

In advantageous embodiments, the glazing according to the invention may exhibit acoustic insulation (determined for example by measuring the acoustic weakening index, particularly according to standard ISO 10140) higher than an identical glazing but not comprising any perforations arranged periodically in the plates of the device, over a frequency range from 200 Hz to 2000 Hz, preferably from 100 Hz to 5000 Hz, still preferably from 50 Hz to 20,000 Hz.

The glazing according to the invention can be used in any application that uses glazing. In particular, the glazing according to the invention can be a building glazing. The glazing can be intended to serve as an interface between the outside and the inside of the building and can be for example a facade glazing, window glazing or door glazing. Alternatively, the glazing can be intended to be placed inside the building.

The invention likewise relates to a method for manufacturing a glazing as disclosed herein before, comprising:
providing at least two glass walls;
providing a device as described hereinbefore;
arranging the two glass walls so as to form a cavity therebetween; and
introducing the device into the cavity.

In a particularly preferred way, the device is placed in the cavity of the glazing so that the chamber delimited by the perforated plate of the device is in fluid communication with the cavity of the glazing via the perforations of the device plate.

Preferably, when the device is a spacer device, the manufacturing method comprises a step of attaching the two glazed walls to the spacer device. More preferentially, when the spacer device comprises at least one perforated profile 1, the two glazed walls are attached to the spacer device in such a way that the upper wall 3 of the profile(s) 1 of the spacer device comprising the perforations 6 arranged periodically faces the cavity formed between the glazed walls of the glazing.

### EXAMPLES

The following examples illustrate the invention in a non-limiting manner.

### Example 1—Measurement of the Acoustic Absorption

The acoustic absorption of different metal devices was measured using an impedance tube (Kundt tube) with a diameter of 100 mm.

Three devices each comprising five aluminum profiles having a chamber with a thickness of 5.65 mm (between their upper wall and their lower wall) and a wall with a thickness greater than 0.35 mm were manufactured. In each device, the five profiles were attached to one another by their side faces, the five profiles being arranged in the same orientation (the upper walls of the profiles are all in the same main plane).

In two of the three devices, perforations were pierced in the upper wall of each profile, periodically (along a longitudinal axis of the profile passing through the middle of the width of the profile), the third device was left without perforations. With the exception of the perforations, the three devices are identical.

The perforations of the three devices have the following characteristics:
device no. 1: perforations with a diameter of 0.8 mm, the distance between the centers of two adjacent perforations being 15 mm;
device no. 2: perforations with a diameter of 1 mm, the distance between the centers of two adjacent perforations being 30 mm;
device no. 3: no perforation.

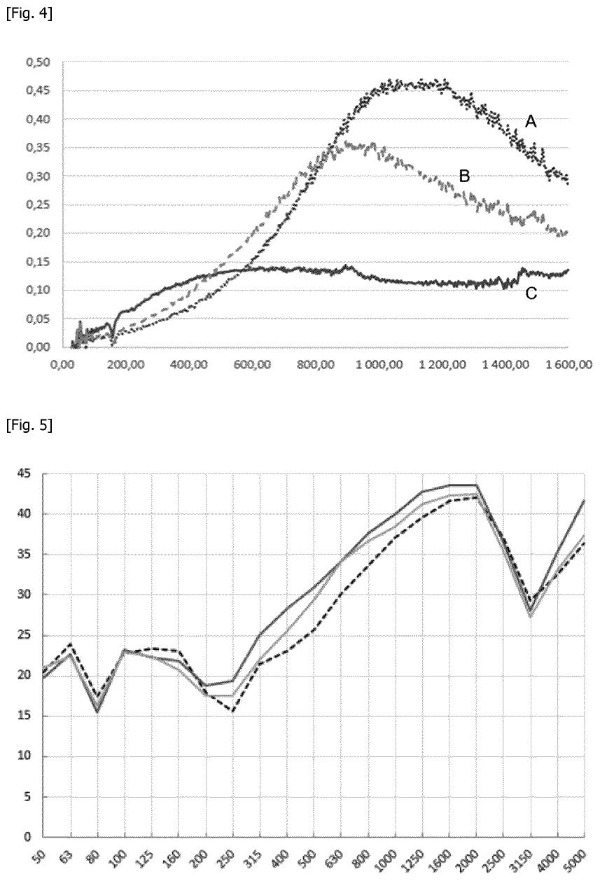

The acoustic absorption of each of the three devices tested as a function of frequency was measured according to standard ISO 10534-2. The results are shown in FIG. 4.

It is noted that devices no. 1 and no. 2 have a higher acoustic absorption coefficient above a certain frequency. Better absorption of the sound energy is reflected, in a glazing, by better acoustic insulation.

An absorption peak for device no. 1 at approximately 1200 Hz and an absorption peak for device no. 2 at approximately 1000 Hz are observed. In order to obtain the absorption peaks of the profiles in lower frequencies, the thickness of the chamber may be increased.

### Example 2—Measurement of the Acoustic Insulation of Glazings

A first glazing according to the invention (glazing no. 1) was manufactured. This glazing comprises two rectangular glass walls of non-laminated non-tempered monolithic glass, each having the following dimensions: 1480 mm long, 1230 mm wide and 4 mm thick. The two glazed walls are secured to a spacer device in a peripheral zone of the glazed walls, so as to form between them a cavity with a thickness of 16 mm. The cavity of the glazing comprises air. The spacer device consists of four profiles forming a frame. Each profile consists of a tube with a rectangular cross section comprising an upper wall, a lower wall opposite the upper wall and two side walls, connecting the upper wall to the lower wall, on which the glazed walls are attached. Each profile has a chamber with a thickness of 15 mm (between its upper wall and its lower wall) and with a width of 16 mm. Two of the profiles have a length of 1440 mm and the other two profiles have a length of 1165 mm. The profiles are made of composite material including fiberglass and have walls with a thickness of 1.2 mm. The upper wall of each profile comprises perforations aligned and distributed periodically along a longitudinal axis of the profile passing through the middle of the width of the profile. The perforations have a diameter of 4 mm and the distance between the centers of two adjacent perforations is 80 mm.

A second glazing according to the invention (glazing no. 2) was manufactured. This glazing is identical to glazing no. 1 except that the distance between the centers of two adjacent perforations is 110 mm and the chambers of the profiles comprise a glass wool lamella, sold by Isover under the trade name Domisol LV, of the same length as the profile in which it is located (that is to say 1440 mm or 1165 mm depending on the profile), with a width of 15 mm and a thickness of 15 mm.

A comparative double glazing (glazing no. 3) of the 4(16)4 type was also manufactured. This double glazing differs from glazing no. 1 only in that the profiles do not comprise any perforation.

The spectrum of the acoustic insulation index (R) of the three glazings was measured as a function of frequency, per the measurement protocol defined by standard ISO 10140.

The results are shown in FIG. 5 and in the table below.

TABLE 1

| Acoustic | Glazing | Glazing | Glazing |
|---|---|---|---|
| index | no. 1 | no. 2 | no. 3 |
| R_{A} (dB) | 29.7 | 31.2 | 28.9 |
| R_{A, tr} (dB) | 27.2 | 28.8 | 26.2 |
| R_{w}(C; Cₜᵣ) | 31(−1; −4) | 33(−2; −4) | 30(−1; −4) |
| (dB) | | | |

The acoustic indices are determined according to standard ISO 717-1.

It can be seen that the presence of periodic perforations in the profiles of the spacer device allow for an improvement in the acoustic performance of the glazing, in particular for the frequencies around the mass/spring/mass frequency of the glazing, but also for frequencies greater than the mass/spring/mass frequency of the glazing, particularly for the frequencies between 200 and 2000 Hz. An increase in the acoustic indices R_{W}, R_{A} and R_{A,tr} is thus observed, for glazings no. 1 and no. 2, compared with the comparative glazing. In addition, the presence of mineral wool in the profiles of the spacer device allows an additional improvement of the acoustic insulation of the glazing.

As already mentioned, a device according to the invention is also remarkable in that it greatly limits the presence of moisture between the glass walls of the glazing. Such properties are therefore added to those described above in relation to acoustic insulation, resulting in a much higher-performance glazing than that of the prior art.

In its general principle, with regard to the aspects linked to limiting the presence of moisture between the glass walls of the glazing, the invention consists in equipping the glazing device with desiccant means configured to absorb moisture in the chamber delimited by the plate of said device.

By “desiccant means”, reference is typically made to means which have the property of drying the atmosphere in which they are placed, or, in other words, of absorbing all or part of the moisture contained in this atmosphere. The use of such desiccant means reflects a desire to absorb moisture before it turns to water.

A description will now be given of various embodiments of the glazing device, wherein such desiccant means are present. More particularly, these different aim to embodiments describe different configurations/layouts/arrangements of said desiccant means.

For the sake of simplicity, the description of these embodiments is carried out assuming that the glazing device conforms to that described above with reference to FIG. 1. Of course, the invention is not limited to such considerations, and all the embodiments described below can be adapted without difficulty, according to any technically operative combinations, to other configurations (bar, casing, etc.) described previously.

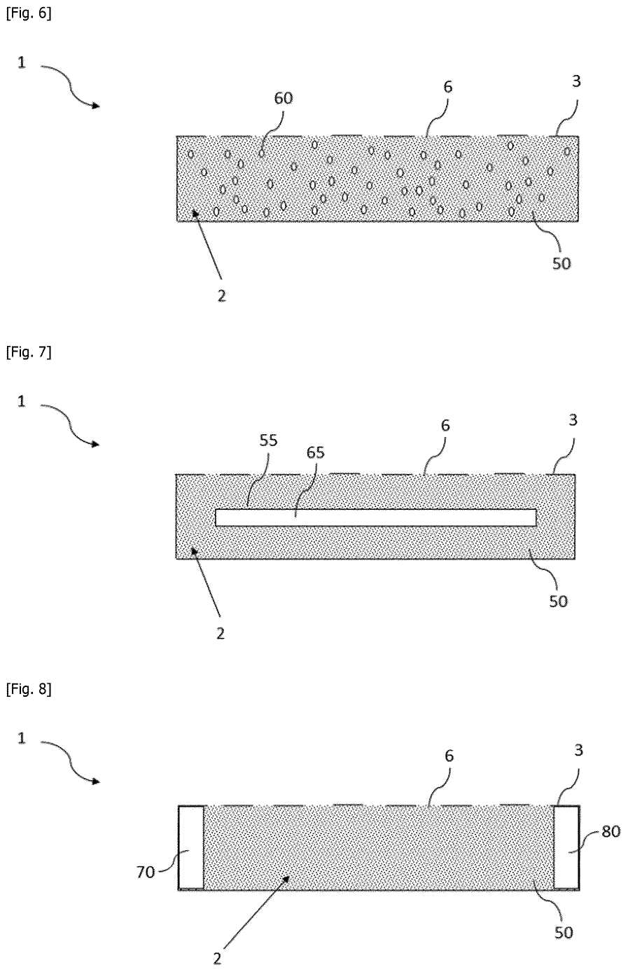

FIG. 6 schematically shows a longitudinal cross-sectional view of a particular embodiment of the device 1 shown in FIG. 1.

As shown in FIG. 6, the device 1 in this embodiment comprises a porous absorbent material 50 maintained in a fixed position inside the chamber 2. Said porous absorbent material 50 complies with the characteristics already mentioned above. In particular, it is preferably selected from the group consisting of mineral wools, fibrous textile, polymer foams and combinations thereof.

In particular, the porous absorbent material 50 occupies the entire volume of chamber 2. It is therefore easy to understand that this configuration within chamber 2 means that the porous absorbent material 50 is maintained in a fixed position.

Additionally, in the embodiment shown in FIG. 6, the desiccant means of device 1 comprise “internal” desiccant means arranged inside chamber 2. More particularly, said internal desiccant means comprise granules 60 embedded, preferentially in a non-agglomerated manner (that is, in an individualized manner), in the porous absorbent material 50.

These granules (60) are made, for example, of molecular sieve, silica gel, calcium chloride (CaCl₂)), sodium sulfate (Na₂SO₄), activated carbon, or zeolites with the chemical formulation M2/nO·Al2O3·xSiO2·yH2O, where M can be replaced by Ca, Mg, K or Na. In general, any material known to a person skilled in the art for producing desiccant means can be used as granules.

It is understood that in the embodiment shown in FIG. 6, because the porous absorbent material 50 is maintained fixed in chamber 2, the internal desiccant means in the form of granules 60 are also maintained fixed therein. This advantageously prevents any release of the granules 60 through the perforations 6 in the upper wall 3.

Furthermore, it is important to note that considering a porous absorbent material 50 occupying the entire volume of chamber 2 is only one alternative implementation of the invention. Thus, this does not preclude other configurations, such as for example one in which the porous absorbent material 50 occupies only part of the volume of chamber 2 and is maintained fixed therein by any method known to a person skilled in the art, for example using suitable adhesive means.

FIG. 7 schematically shows a longitudinal cross-sectional view of still another embodiment of the device 1 shown in FIG. 1.

As shown in FIG. 7, the device 1 comprises a porous absorbent material 50 having the same features (in terms of the materials from which it can be made) as those described with reference to FIG. 6, and occupying the entire volume of chamber 2.

Unlike the embodiment shown in FIG. 6, wherein granules 60 were used, the internal desiccant means herein comprise a bar 65 arranged in a cavity 55 of said absorbent material 50.

There are no restrictions on the shape of the bar 65. For example, the bar 65 may be parallelepipedic or else cylindrical. According to other examples, the cross-section of the bar 65 may be shaped like a rhombus, star, etc.

Said bar 65 is made of a solid material, such as for example a material such as those mentioned above with reference to the granules in FIG. 6, and occupies the entire space delimited by cavity 55. The positioning of the bar 65 in the cavity 55 can be achieved by inserting, or by injecting the desiccant material.

Of course, similarly to what has been described with reference to FIG. 6, there is nothing to preclude the possibility that the porous absorbent material 50 occupies only part of the volume of chamber 2 and is maintained fixed therein by any method known to a person skilled in the art, for example using suitable adhesive means. Nor does it rule out the possibility that the bar 65 occupies only part of the space delimited by the cavity 55.

Additionally, the invention also covers embodiments wherein the porous material 50 comprises not only granules 60 but also a cavity 55 within which a bar 65 is housed.

FIG. 8 schematically shows a longitudinal cross-sectional view of still another embodiment of the device 1 shown in FIG. 1.

As shown in FIG. 8, the device 1 comprises a porous absorbent material 50 having the same features (in terms of the materials from which it can be made) as those described with reference to FIG. 6.

Additionally, in this embodiment, the device 1 comprises internal desiccant means maintained in a fixed position in chamber 2 and comprising two envelopes 70, 80 respectively arranged at opposite ends of chamber 2, each of said envelopes 70, 80 comprising granules having the same characteristics as those described with reference to FIG. 8.

Each envelope 70, 80 can be made of a flexible or rigid material, such as for example paper, plastic, polymer or plant or woven fibers. Of course, as each envelope 70, 80 and the granules contained therein belong to the desiccant means of device 1, said envelope 70, 80 is provided with perforations allowing the granules to absorb moisture. These perforations are typically smaller in diameter than the granules, to prevent them from escaping from the envelope 70, 80 containing them.

Furthermore, in the embodiment described herein with reference to FIG. 8, the fixed position of said envelopes 70, 80 is maintained by (direct) contact of each of them with the inner wall of the chamber 2 and the porous absorbent material 50. To achieve this, said porous absorbent material 50 occupies the entire remaining volume of chamber 2, that is, the total volume of chamber 2 minus the respective volumes of the two envelopes 70, 80.

The embodiment in FIG. 8 may be presented in the form of multiple alternatives. For example, the following alternatives may be considered, optionally combined where technically feasible:
the porous absorbent material 50 comprises granules, as already described with reference to FIG. 6, and/or a bar 65, as already described with reference to FIG. 7,
the porous absorbent material 50 is not in contact with at least one of the two envelopes 70, 80, possibly with both envelopes 70, 80, so as to occupy a smaller volume than the volume left free by the two envelopes 70, 80 within chamber 2. Consequently, each envelope 70, 80 that is not in contact with the porous absorbent material 50 is maintained fixed inside the chamber 2 by any method known to a person skilled in the art, for example using suitable adhesive means. The porous absorbent material 50 is maintained in a fixed position with similar features,
no porous absorbent material is present in the volume left free by the two envelopes 70, 80 within chamber 2.

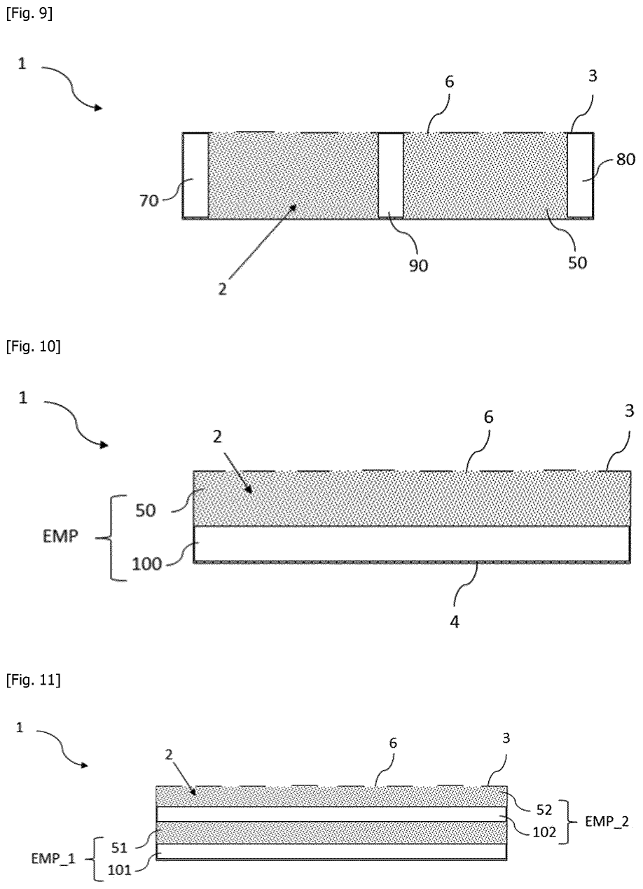

Furthermore, the embodiment of FIG. 8 has so far been described in terms of the presence of two envelopes 70, 80. It should however be noted that the number of envelopes does not constitute a limitation of the invention. Thus, there is nothing to preclude the possibility of a single envelope or even more than two envelopes, for example three envelopes 70, 80, 90, with two envelopes 70, 80 respectively arranged at opposite ends of chamber 2 and one envelope 90 arranged substantially centrally between said two envelopes 70, 80, as shown in FIG. 9 in a non-limiting manner.

Finally, regardless of the number of envelopes envisaged, the positioning thereof within the chamber 2 does not constitute a limitation of the invention.

FIG. 10 schematically shows a longitudinal cross-sectional view of still another embodiment of the device 1 shown in FIG. 1.

As shown in FIG. 10, device 1 comprises a porous absorbent material 50 having the same features (in terms of the materials from which it can be made) as those described with reference to FIG. 6.

Additionally, in this embodiment, the device 1 comprises internal desiccant means maintained in a fixed position in chamber 2 and comprising a plate 100, called “absorbent” plate, made from a solid material, for example a material such as those mentioned above with reference to the granules shown in FIG. 6. “Plate” herein refers to a rigid element with a (substantially) flat surface.

More particularly, in the embodiment shown in FIG. 10, the plate 100 extends horizontally over the entire inner surface of the lower wall 4 of the device 1, without occupying the entire volume of chamber 2. The remaining volume of chamber 2 is entirely occupied by the porous absorbent material 50. In this way, a stack of a first layer and a second layer, called “absorbent stack” EMP, is obtained, said two layers being parallel to the perforated plate 3 of the device 1.

The fact that said absorbent stack EMP occupies the entire internal volume of chamber 2 ensures that it is maintained in a fixed position.

The embodiment in FIG. 10 may be presented in the form of multiple alternatives. For example, the following alternatives may be considered, optionally combined where technically feasible:
only the absorbent plate 100 is present in chamber 2, with no porous absorbent material 50 being used,
the absorbent plate 100 extends horizontally over only part of the inner surface of the lower wall 4 of the device 1,
the porous absorbent material 50 occupies a smaller volume than the volume left free by the absorbent plate 100,
the porous absorbent material 50 comprises granules, as already described with reference to FIG. 6, and/or a bar 65, as already described with reference to FIG. 7.

Furthermore, the embodiment in FIG. 10 has, up until now, been described on the basis of a single absorbent stack EMP. However, it should be noted that the number of such absorbent stacks does not constitute a limitation of the invention. Thus, there is nothing to preclude the possibility of more than one absorbent stack, for example two absorbent stacks EMP_1, EMP_2 superimposed so as to fill the internal volume of the chamber 2, as shown in FIG. 11 in a non-limiting manner. In the example shown in FIG. 11, stack EMP_1 (respectively stack EMP_2) comprises a plate 101 (respectively a plate 102) and a layer of porous absorbent material 51 (respectively a layer of porous absorbent material 52).

The internal desiccant means have so far been described as being maintained in a fixed position in the chamber 2 of the device 1. However, the invention is not limited to these considerations, as the invention covers still other embodiments wherein only part, or even none, of said internal desiccant means is fixed. These other embodiments are preferentially implemented when the device 1 is positioned in the lower part of the glazing, so that the internal desiccant means not held in a fixed position cannot escape through the perforations 6 due to the action of gravity.

Moreover, up until now it has been considered that the device 1 comprises only internal desiccant means. However, there is nothing to preclude the possibility of still other embodiments wherein the desiccant means of the device 1 comprise, solely or in combination with internal desiccant means, desiccant means fixedly arranged outside said chamber 2, called “external desiccant means”, in contact with the perforated plate 3 and arranged so as to leave said perforations 6 free.

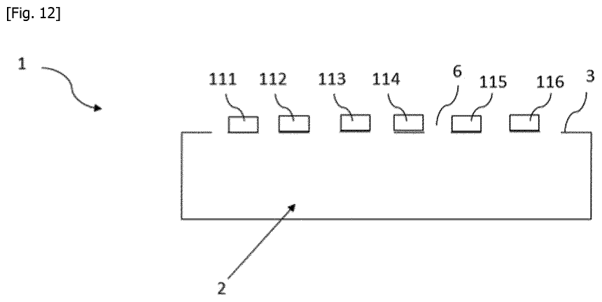

By way of example, a configuration of this type is shown schematically in FIG. 12. More particularly, in this example, the desiccant means comprise only external desiccant means formed by six bars 111, 112, 113, 114, 115, 116 made of a solid material having, for example, the same features as those described with reference to the plate 100 in FIG. 10.

Said bars 111, 112, 113, 114, 115, 116 are positioned in contact with the perforated plate 3, each bar being separated from an adjacent bar by a perforation 6. Furthermore, each bar is maintained in a fixed position by any method known to a person skilled in the art, for example using suitable adhesive means.

Of course, six bars as external desiccant means is only one alternative of the invention. There is not nothing to preclude the possibility of a different number of bars, as there is no limitation in this respect.

Additionally, considering external desiccant means in the form of bars does not constitute a limitation of the invention either. To this end, the external desiccant means can take any of the forms described above with reference to the embodiments wherein which the device 1 comprises internal desiccant means.

1. A glazing comprising at least two glass walls forming a cavity therebetween, wherein the cavity comprises at least one device comprising at least one plate, said plate comprising a plurality of perforations arranged periodically and delimiting at least one chamber arranged in the cavity, the device further comprising desiccant means configured to absorb moisture present in said at least one chamber.

2. The glazing according to claim 1, wherein the desiccant means comprise desiccant means arranged inside said at least one chamber forming internal desiccant means.

3. The glazing according to claim 2, wherein a porous absorbent material is present inside said at least one chamber, said internal desiccant means comprising granules embedded in said porous absorbent material and/or a bar arranged in a cavity of said porous absorbent material.

4. The glazing according to claim 2, wherein the internal desiccant means comprise granules collected in at least one envelope.

5. The glazing according to claim 4, wherein at least one envelope is maintained in a fixed position by contact with an inner wall of said at least one chamber and a porous absorbent material present inside said at least one chamber.

6. The glazing according to claim 4, wherein said at least one envelope comprises:
two envelopes respectively arranged at opposite ends of said at least one chamber, or
three envelopes, including two envelopes respectively arranged at opposite ends of said at least one chamber as well as an envelope arranged substantially centrally between said two envelopes arranged at the ends.

7. The glazing according to claim 2, wherein the internal desiccant means comprise at least one plate made of a solid material forming an absorbent plate.

8. The glazing according to claim 7, wherein said internal desiccant means comprise a stack of a first layer and a second layer, forming an absorbent stack, the first layer being an absorbent plate and the second layer being a porous absorbent material present inside said at least one chamber.

9. The glazing according to claim 8, wherein the internal desiccant means comprise a plurality of absorbent stacks.

10. The glazing according to claim 2, wherein all or some of the internal desiccant means are maintained in a fixed position in said at least one chamber.

11. The glazing according to claim 1, wherein the desiccant means comprise desiccant means fixedly arranged outside said at least one chamber, forming external desiccant means, in contact with the perforated plate of said at least one chamber and arranged so as to leave said perforations free.

12. The glazing according to claim 1, wherein said at least one perforated plate comprises at least three perforations.

13. The glazing according to claim 1, comprising at least two plates, each of the at least two plates comprising a plurality of perforations arranged periodically and delimiting a chamber arranged in the cavity.

14. The glazing according to claim 1, wherein at least one perforated plate and the at least one chamber delimited thereby are configured to resonate at a low frequency.

15. The glazing according to claim 1, wherein at least one perforated plate and the at least one chamber delimited thereby are configured to resonate at the mass/spring/mass frequency of the glazing.

16. The glazing according to claim 15, wherein the device further comprises:
at least one second plate comprising a plurality of perforations arranged periodically and delimiting a second chamber arranged in the cavity, said second plates and chamber being configured to resonate at the frequency one octave-third less than the mass/spring/mass frequency of the glazing; and
at least one third plate comprising a plurality of perforations arranged periodically and delimiting a third chamber arranged in the cavity, said third plate and chamber being configured to resonate at the frequency one octave-third greater than the mass/spring/mass frequency of the glazing.

17. The glazing according to claim 1, wherein the device is a spacer device attached to each of the two glass walls and comprises:
at least one rectilinear tubular profile comprising an upper wall forming said at least one perforated wall, or
at least one rectilinear bar, wherein the bar forms said at least one perforated plate.

18. The glazing according to claim 1, wherein the device is positioned in a peripheral zone of the cavity of the glazing.

19. The glazing according to claim 1, being a glazing of a building.

20. The glazing according to claim 1, wherein the at least one chamber delimited by the at least one perforated plate is in fluid communication with the cavity of the glazing formed between the glass walls via the perforations in the perforated plate.

21. The glazing according to claim 1, wherein a ratio between a surface area of all the perforations of the at least one perforated plate arranged periodically and the total surface area of the plate is from 0.001% to 8%.

22. The device comprising at least one plate, said plate comprising a plurality of perforations arranged periodically, said device being suitable for manufacturing glazing according to claim 1.
